(19) United States
(12) Patent Application Publication
(10) Pub. No.: US 2019/0041872 A1
(43) Pub. Date: Feb. 7, 2019

(54) METHOD, AN UNMANNED AERIAL VEHICLE, A SYSTEM AND A CONTROL CIRCUIT FOR EMERGENCY OPERATION

(71) Applicant: Intel IP Corporation, Santa Clara, CA (US)

(72) Inventors: Tobias LANG, Seefeld (DE); Daniel GURDAN, Germering (DE)

(21) Appl. No.: 15/857,659

(22) Filed: Dec. 29, 2017

(51) Int. Cl. G05D 1/06; B64C 39/02; B64D 47/02; B64D 45/00

(52) U.S. Cl. CPC G05D 1/0676; B64C 39/024; B64D 47/02; B64C 2201/042; B64C 2201/141; B64C 2201/108; B64C 2201/027; B64D 45/00

(57) ABSTRACT

A control circuit for an unmanned aerial vehicle includes a first interface configured to control at least one of the following components of the unmanned aerial vehicle: a motor or a light source. The circuit includes a second interface configured to communicate with an optoelectronic sensor of the unmanned aerial vehicle. The circuit includes one or a plurality of processors configured to implement at least one sequence of the following sequences via the first interface: a landing sequence bringing the unmanned aerial vehicle to land or to discontinue flight; or a light emission sequence of pulsed or permanent light. The one or a plurality of processors may be further configured to initiate the at least one sequence via the first interface in response to an alert command received via the second interface.

### TECHNICAL FIELD

Various embodiments relate generally to an unmanned aerial vehicle, a system and a control circuit.

### BACKGROUND

In general, geo-fencing finds expanding usage in the field of autonomous flight. Illustratively, a geo-fence is a virtual perimeter for a real-world geographic area. In combination with a positioning system, geo-fencing allows a restriction of the autonomous flight to inside or outside the geographic area. For example, exiting or entering the geo-fence may trigger an alert to the operator. Conventional geo-fencing requires a position-aware service to provide for permanently checking of the flight position in relation to the geo-fence.

For example, geo-fencing facilitates handling of autonomous drone-fleets with a high number of drones, e.g., tens, hundreds or thousands of drones. Such drone-fleets, for example, are used for flight and/or light shows, decorative illumination or other events and entertainments at least one alert sequence well as dispatch and/or monitoring. However, the operations required for autonomous drone-fleets increase exponentially with the number of drones and are not easily to scale. By geo-fencing, the operation of the whole drone-fleet can be restricted to or from a predefined area, such as a protected airspace, the audience or other undesirable places.

### SUMMARY

A control circuit for an unmanned aerial vehicle includes a first interface configured to control at least one of the following components of the unmanned aerial vehicle: a motor or a light source. The circuit includes a second interface configured to communicate with an optoelectronic sensor of the unmanned aerial vehicle. The circuit includes one or a plurality of processors configured to implement at least one sequence of the following sequences via the first interface: a landing sequence bringing the unmanned aerial vehicle to land or to discontinue flight; or a light emission sequence of pulsed or permanent light. The one or a plurality of processors may be further configured to initiate the at least one sequence via the first interface in response to an alert command received via the second interface.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a method in a schematic flow diagram according to various embodiments;

FIGS. 2 to 4 respectively show a method in a various views according to various embodiments;

FIG. 5 shows an UAV in a schematic perspective view according to various embodiments; and

FIGS. 6 to 11 respectively show a method in a various views according to various embodiments.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The terms “at least one” and “one or more” may be understood to include a numerical quantity greater than or equal to one (e.g., one, two, three, four, [. . .], etc.). The term “a plurality” may be understood to include a numerical quantity greater than or equal to two (e.g., two, three, four, five, [. . .], etc.).

The words “plural” and “multiple” in the description and the claims expressly refer to a quantity greater than one. Accordingly, any phrases explicitly invoking the aforementioned words (e.g. “a plurality of [objects]”, “multiple [objects]”) referring to a quantity of objects expressly refers more than one of the said objects. The terms “group (of)”, “set [of]”, “collection (of)”, “series (of)”, “sequence (of)”, “grouping (of)”, etc., and the like in the description and in the claims, if any, refer to a quantity equal to or greater than one, i.e. one or more. The terms “proper subset”, “reduced subset”, and “lesser subset” refer to a subset of a set that is not equal to the set, i.e. a subset of a set that contains less elements than the set.

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, a plurality of a multiple of listed elements, or each of the listed elements. The phrase “at least one of” with regard to a single element may be used herein to mean one individual element or more than one element.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The term “processor” or “controller” as, for example, used herein may be understood as any kind of entity that allows handling data, signals, etc. The data, signals, etc. may be handled according to one or more specific functions executed by the processor or controller.

A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “system” (e.g., a drive system, a position detection system, etc.) detailed herein may be understood as a set of interacting elements, the elements may be, by way of example and not of limitation, one or more mechanical components, one or more electrical components, one or more instructions (e.g., encoded in storage media), one or more controllers, etc.

The term “circuit” may be understood as any kind of a logic implementing entity, which may be special purpose circuitry or a processor executing software stored in a memory, firmware, or any combination thereof. Thus, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code such as e.g., Java.

Any other kind of implementation of the respective functions which will be described in more detail below may also be understood as a “circuit”. It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, “memory” may be understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

The term “position” used with regard to a “position of an unmanned aerial vehicle”, “position of an object”, “position of an obstacle”, and the like, may be used herein to mean a point or region in a two- or three-dimensional space. It is understood that suitable coordinate systems with respective reference points are used to describe positions, vectors, movements, and the like.

The term “geo-fence”, may be used herein to mean a (e.g., virtual) boundary for a geographic (e.g., real-world) region, which may than be also referred as to “geo-fenced region”. The geographic region may be two- or three-dimensional in space. Geolocation can be understood as determination or estimation of the real-world geographic location of an object, such as an UAV or a region. It is understood that suitable coordinate systems (e.g., a geolocation coordinate systems) with respective reference points are used to describe positions, vectors, movements, and the like, for example, latitude and longitude coordinates and/or altitude. For example, the geo-fence may limit the geographic region at its vertical extension, e.g., its top and/or bottom. Additionally or alternatively, the geo-fence may limit the geographic region at its horizontal extension, e.g., only at one side, at opposite sides, surrounding a certain angel of the full geographic region. For example, the geo-fenced region may be distant from ground or limited by the ground. Additionally or alternatively, the geo-fenced region may be a vertical projection of a two-dimensional (e.g., horizontal) plane towards the ground.

A geo-fence may be implemented based on a geolocation system (also referred as to geolocation-based geo-fence) by providing data defining the position, orientation and/or shape of the virtual boundary in two- or three-dimensional space. The data may be provided to the one or more UAVs, which frequently determine their geolocation relation regarding the geo-fence using the geolocation system. Optionally, there may be defined an “inside” and “outside” of the geo-fence, e.g., if the geo-fence is perimeter. A particular type of geolocation system is a positioning system. The positioning system may include but not be limited to a global system, e.g., Global Positioning System (GPS), Global Navigation Satellite System (GLONASS, BeiDou, IRNSS or Galileo) or another satellite-based and/or radio-based navigation system, e.g., a space-based radio navigation system or a global navigation satellite system. Additionally or alternatively, the positioning system may also include a regional local navigation system, e.g., long-range navigation (LORAN), or include a site-wide system, e.g., an indoor navigation system (e.g., Active Bat) or another hotspot based site-wide system and/or ultrasonic based site-wide system.

Additionally or alternatively to the geolocation-based geo-fence, a non-geolocation-based geo-fence may be provided (also referred as to beam based geo-fence) by emitting a beam that represents the position of boundary. Illustratively, beam based geo-fence provides for a radiation-fence that represents the position of boundary. The emission characteristic of the beam may define the (e.g., geostationary) position, orientation and/or shape of the boundary in two- or three-dimensional space. The beam based geo-fence may be implemented by providing a controlling routine (e.g., implemented by software and/or hardware) to the UAV, which initiates a predefined reaction if the UAV receives the beam (e.g., recognizes that it is hit by the beam).

Generally, a beam may be understood as directional emission and/or projection of radiation (e.g., light) from a radiation source (illustratively, a bundle of rays). For example, the beam may include or be formed from collimated radiation and/or coherent radiation. The directional emission may be understood as at least the radiance of the emitted radiation and may include an angular dependency. The directional emission may be described by a variety of parameters, such as directivity (D), beam divergence (0) and/or cross-sectional extension (d).

In general, geometric relations of the beam, e.g., the cross-section or the cross-sectional extension (also referred as to beam extension) may be understood as being perpendicular to the beam direction (also referred as to beam axis or beam propagation direction), in other words to the emission direction.

The directivity (D) is a parameter of a radiation source that measures the degree to which the radiation emitted is concentrated in a single direction. The directivity is related to the beam divergence, which is angular measure of the increase in beam extension (d) with distance (l) from the radiation source (illustratively, the spreading of the beam with distance). In other words, the beam extension (d) is a function of the distance (l) from the radiation source, that is d=d(l). Since a beam typically does not have sharp edges, the diameter can be defined by choosing two diametrically opposite points, at which the irradiance of the beam is a specified fraction of the beam's peak irradiance, and taking the distance between them as a measure of the beam's width. The specified fraction can be predefined by different values, for example, according to the D4σ, 10/90 or 20/80 knife-edge, 1/e2, FWHM, and D86 definition. For facilitating understanding, in the following, the beam extension may be defined according to the Full width at half-maximum (FWHM) definition. Illustratively, FWHM definition sets the specified fraction to 50% (correlates to −3 dB). In other words, the beam extension (d) obtained is the full width of the beam at half its maximum intensity (FWHM). This is also called the half-power beam width (HPBW).

The beam divergence (Θ) can be calculated based on the difference of the beam extension (Δd=d(l₁)-d(l₂)) at two separate distances (l₁) and (l₂) from the radiation source and the relative distance (Δ1=l₁-l₂) to each other according to the following equation Θ=2·arctan(Δd/(2.Δl)), or in more general Θ=2·arctan(δd/(2·δl)), wherein δd and δl refer to the differential extension and differential distance. However, the beam divergence (Θ) may be also calculated for other beam extension definitions, e.g., for each of the D4σ, 10/90 or 20/80 knife-edge, 1/e2, FWHM, and D86 definition.

An unmanned aerial vehicle (UAV) is an aircraft that has the capability of autonomous flight. In autonomous flight, a human pilot is not on board and in control of the UAV. The UAV may also be denoted as unstaffed, uninhabited or unpiloted aerial vehicle, -aircraft or -aircraft system or drone.

According to various embodiments, it was recognized that conventional geo-fencing involves a high risk of malfunctioning and inflicting undesired damage. For example, during flying a GPS-controlled drone-fleet, single drones might violate their preprogrammed geo-fence due to GPS-Signal interferences (also referred as to multipath misplacement) or total signal loss (e.g., due to sensor-failure, GPS-jammer).

Conventionally, the multipath misplacement requires a high GPS-quality to recover, and the geo-fence violation may be hidden from the system as long as the GPS-Signal interferes. Therefore, multipath misplacement involves a high risk of unintended and imperiling drone movement and a high risk of remaining undetected. For example, drones affected by multipath misplacement have to be identified and taken down manually before they reach the audience or other undesirable places. Alternatively, the affected drone may be detected by the control-software and taken down by a radio kill-signal.

In reaction of a total signal loss, all voluntarily moving is stopped and the drone descends slowly towards ground on its own motion. However, total signal loss is usually an area wide effect or might be caused by general deactivation and/or jamming due to high security level of the event. Therefore, the whole or the most of the drone-fleet may be affected and there is only a minor chance of self-recovery. Thus, drone operation and geo-fencing in an area with frequently or uncontrolled signal loss faces serious problems.

According to various embodiments, it was recognized, that conventional reaction routines might be too slow or react too late. For example, even when the drone descends slowly towards ground on its own motion, it might drop straight into the audience due to a late reaction. In addition, there is no routing, which effectively might prevent the drones from drifting into the audience. The process of identifying a multipath misplacement is slow and has only low probability of success to be in time, for example, to find the affected drone in time.

Illustratively, an infrared-light based geo-fence (illustratively, an “Infrared Fence”) is provided for generating and/or maintaining a geospatial restriction for operating an UAV or a swarm including a plurality of UAV. The infrared-light based geo-fence utilizes onboard IR-receiver of the UAV and implements a takedown of all UAV that physically pass a certain line (the boundary of the geospatial restriction). However, the provided geospatial restriction is not only limited to infrared-light as also other frequencies may be applicable, as described later in detail.

The infrared-light based geo-fence adds an additional layer of safety to the operation of UAV or swarms including a plurality of UAV 206 (e.g., a swarm) and thus prevents undesired incidents with UAVs, e.g., by hitting the audience or other sensitive areas.

The infrared-light based geo-fence may be further independent of any radio frequency (RF) disturbances, deactivation and/or jamming.

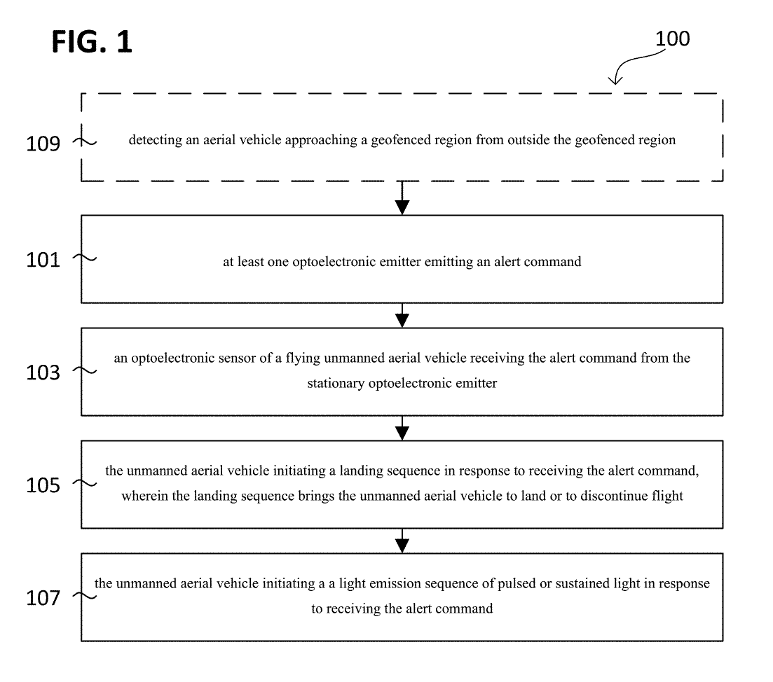

FIG. 1 illustrates a method 100 in a schematic flow diagram according to various embodiments. The method 100 may include in 101, at least one optoelectronic emitter emitting an alert command (also referred as to alert emission 101), in 103, an optoelectronic sensor of a flying unmanned aerial vehicle receiving the alert command from the stationary optoelectronic emitter (also referred as to alert detection 103).

The method 100 may further include in 105, the unmanned aerial vehicle initiating at least one sequence (also referred as alert sequence to) in response to receiving the alert command, e.g., a landing sequence and/or a light emission sequence. For example, the method 100 may include in 105, the unmanned aerial vehicle initiating a landing sequence in response to receiving the alert command, wherein the landing sequence brings the unmanned aerial vehicle to land or to discontinue flight (also referred shortly as to landing sequence 105). Additionally or alternatively to 105, the method 100 may include in 107, the unmanned aerial vehicle initiating a light emission sequence of pulsed or sustained light in response to receiving the alert command (also referred shortly as to highlight sequence 107).

The method 100 may optionally include in 109, detecting an aerial vehicle approaching a geo-fenced region from outside the geo-fenced region (also referred as to intruder detection 109). In this case, the alert emission 101 may be directed into the geo-fenced region and in response to detecting the aerial vehicle. Additionally or alternatively to the intruder detection 109, the or another at least one stationary optoelectronic emitter may repeatedly and/or permanently (as long as at least one UAV 206 is operating in the geo-fenced region) perform the alert emission 101 with a line-beam emission characteristic into a direction having a vertical component, e.g., into a vertical direction z.

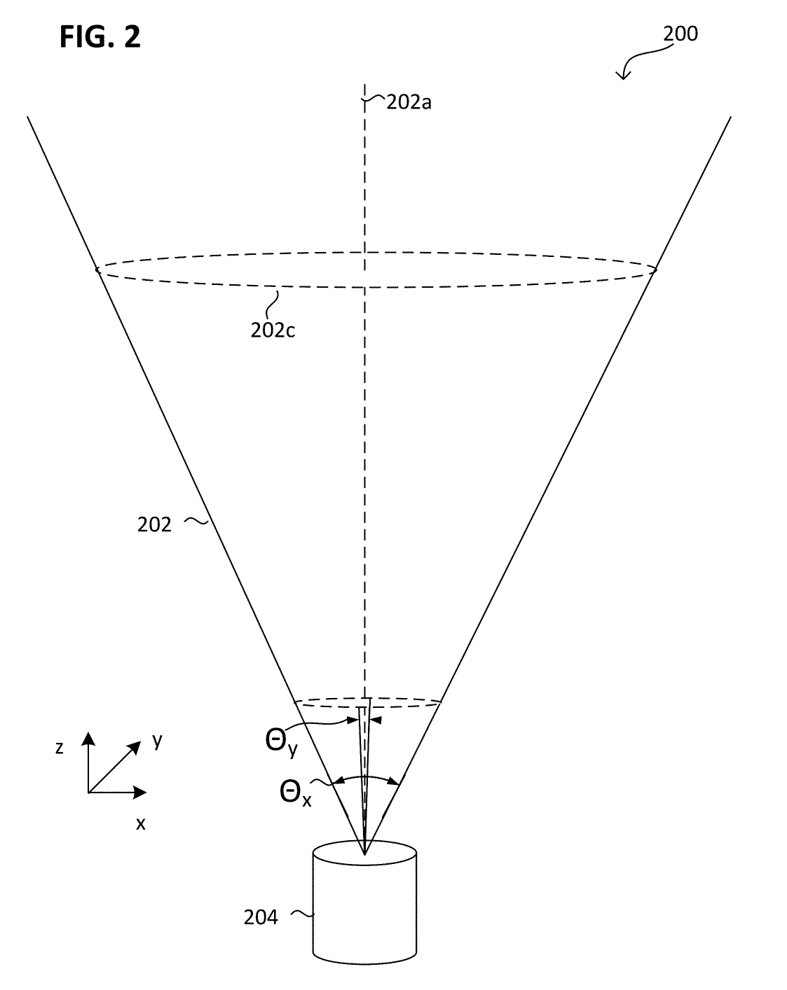

FIG. 2 illustrates the method 100 in a schematic perspective view 200 according to various embodiments.

The alert command may be emitted using a beam 202 of radiation. The radiation may include or be formed from infrared radiation (e.g., having a wavelength in the range between 1 millimeters and 700 nanometers). However, other types of radiation may be used, for example, X-radiation (e.g., having a wavelength in the range between 0.01 nanometers and 10 nanometers), ultraviolet radiation (e.g., having a wavelength in the range between 10 nanometers and 400 nanometers), visible radiation (e.g., having a wavelength in the range between 400 nanometers and 700 nanometers) or other invisible light other than infrared radiation. In general, the beam 202 (also referred as to emission 202) may include or be formed from radiation having a wavelength in the range between 1 millimeters (mm) and 0.01 nanometers (nm).

Emitting the alert command may include modulating the emitted radiation, e.g., by pulse width modulation. For example, the beam 202 may include modulated radiation. For example, the alert command may include or be formed from a sequence of pulses, which may be emitted by the beam 202 of radiation, e.g., with a pulse frequency above about 100 Hertz (Hz), e.g., above about 1 kHz (Kilohertz), e.g., above about 10 kHz.

In general, the alert command may be any kind of command that is capable of being interpreted by the UAV 206, such that the at least one alert sequence is started. In other words, the alert command is configured to instruct the UAV to initiate the alert sequence.

The beam 202 may define the position and/or shape of the geo-fence. For example, the beam 202 may coincide with the boundary of the geo-fenced region. The beam 202 (or simply referred as to geo-fence 202) may be emitted with a line-shaped emission characteristic (also referred as to line-beam emission characteristic or astigmatic emission characteristic). Illustratively, the cross section of the beam 202 may be elongated, e.g., substantially be a line, that is, the beam 202 is the projection of the elongated cross section into the beam direction (e.g., forming a substantially 2-dimensional manifold).

The emission characteristic defines the elongated cross-sectional shape 202c of the beam 202, e.g., being substantially a cross-sectional line-shape. Illustratively, the line-beam emission characteristic may be understood as providing an astigmatic beam; e.g., having an elliptical perimeter 202c or another anisotropic cross-section 202c.

In detail, the line-shaped emission characteristic may provide a first beam divergence (Θₓ) along a first cross sectional direction x of the beam 202 (in other words perpendicular to the emission direction z) and a second beam divergence (Θ_{y}) along a second cross sectional direction y of the beam 202 (in other words perpendicular to the emission direction z). The first cross sectional direction x may be perpendicular to the second cross sectional direction y.

In context to the emission, the first beam divergence (Θₓ) and the second beam divergence (Θ_{y}) may be also referred to as emission divergence. In analogy, the beam direction may be also referred to as emission direction.

The first beam divergence (Θₓ) may be different from (e.g., more than) the second beam divergence (Θ_{y}). In other words, a ratio of the first beam divergence (Θₓ) to the second beam divergence (Θ_{y}) (also referred as to aspect ratio) may be different from one, e.g., greater than about 100, 1000, 10⁴, 10⁵ or more. Additionally or alternatively, the second beam divergence (Θ_{y}) may be less than about 1° (e.g., less than about 0.5° (degree), 0.25°, 10⁻¹°, 10⁻²°, 10⁻³° or less) and/or the first beam divergence (Θₓ) may be more than about 10° (e.g., more than about 30°, 45°, 60°, 90°, 120°, 150° or more, e.g., about 180°).

The extension and/or divergence of the line-shaped emission characteristic may, for example, be measured by capturing an image on a camera, or by using a beam profiler. For example, international standard ISO 11146-2 specifies methods for measuring the beam extension or beam divergence.

For example, the line-shaped emission characteristic may provide a power density distant from the radiation source 204 of more than about 1 mW/cm², e.g., of more than about 2.5 mW/cm², e.g., of more than about 5 mW/cm². For example, the power density may be provided in a distance from the radiation source 204 of more than about 10 m (Meter), e.g., of more than about 25 m, e.g., of more than about 50 m, e.g., of more than about 100 m, e.g., of more than about 200 m.

In general, the alert command may be emitted by one or more than one beam, e.g., a plurality of beams. For example, the one beam may sequentially scan across a series of positions. Upon completion of the scanning sequence, the beam may return to a position of origin and repeat the scanning sequence. Said sequence may be repeated as long as a UAV is present within the geo-fenced region. A plurality of beams may be spatially distributed to cover a plurality of directions or positions simultaneously.

The one or more than one beam 202, that is the alert command, may be emitted by a radiation source 204. The radiation source 204 may include or be formed from one or more than one optoelectronic emitter. An optoelectronic emitter may be understood as including a solid-state light source, such as, for example, a diode (e.g., laser diode, e.g., an injection laser diode), a laser (e.g., a quantum cascade laser), a light-emitting diode (e.g., an organic or inorganic light-emitting diode). Additionally or alternatively, the optoelectronic emitter may include or be formed from a photoelectric emitter, photovoltaic emitter and/or be configured to provide stimulated emission.

In general, the line-shaped emission characteristic may be provided by various configurations, among others by widening and/or splitting one or more than one (e.g., static) beam, superimposing a plurality of (e.g., static) beams and/or by scanning one or more than one beam.

For example, the line-shaped emission characteristic may be provided by an optical system of the radiation source 204. The optical system may include one or more than one optical elements, e.g., one or more than one lens (e.g., a cylindrical lens, lenticular lens, collimator lens, or the like), one or more than one beam splitter, one or more than one beam widener and/or one or more than one mirror (e.g., a concave mirror, or the like). Optionally the optical elements may be configured to provide a beam movement, e.g., a beam scanning.

For example, the optical system may be configured to (statically) widen incoming radiation along the first direction x, e.g., distribute the radiation along the first direction x, and output radiation with the line-shaped cross section. Other configurations for the line-shaped cross emission characteristic are described in the following.

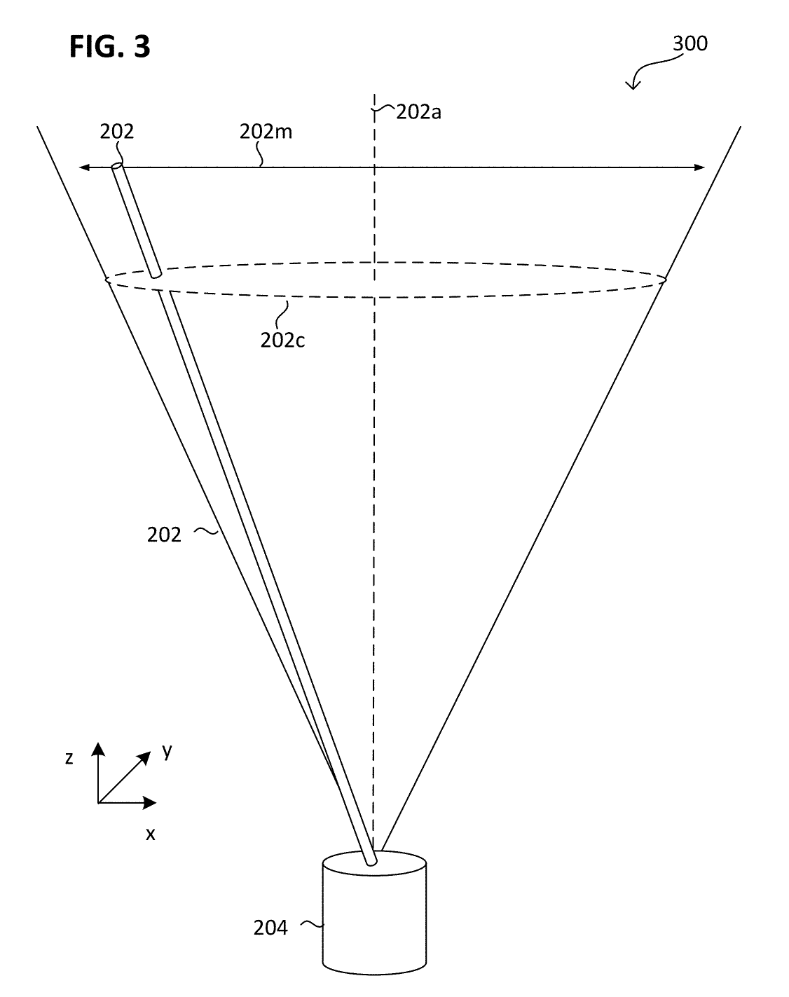

FIG. 3 illustrates the method 100 in a schematic perspective view 300 according to various embodiments. The line-shaped emission characteristic may be provided by a time-dependent optical system. For example, the one or more than one lens and/or one or more than one mirror may oscillate 202m along the first direction x, e.g., driven by one or more than one galvanometer. For example, a laser scanner reflects the laser beam on small mirrors, which are mounted on galvanometers to which a control voltage is applied. For example, the line-shaped emission characteristic may be optionally be understood as averaged over a period, e.g., over 1 second or over the period (e.g., cycle duration) of the oscillation of the time-dependent optical system.

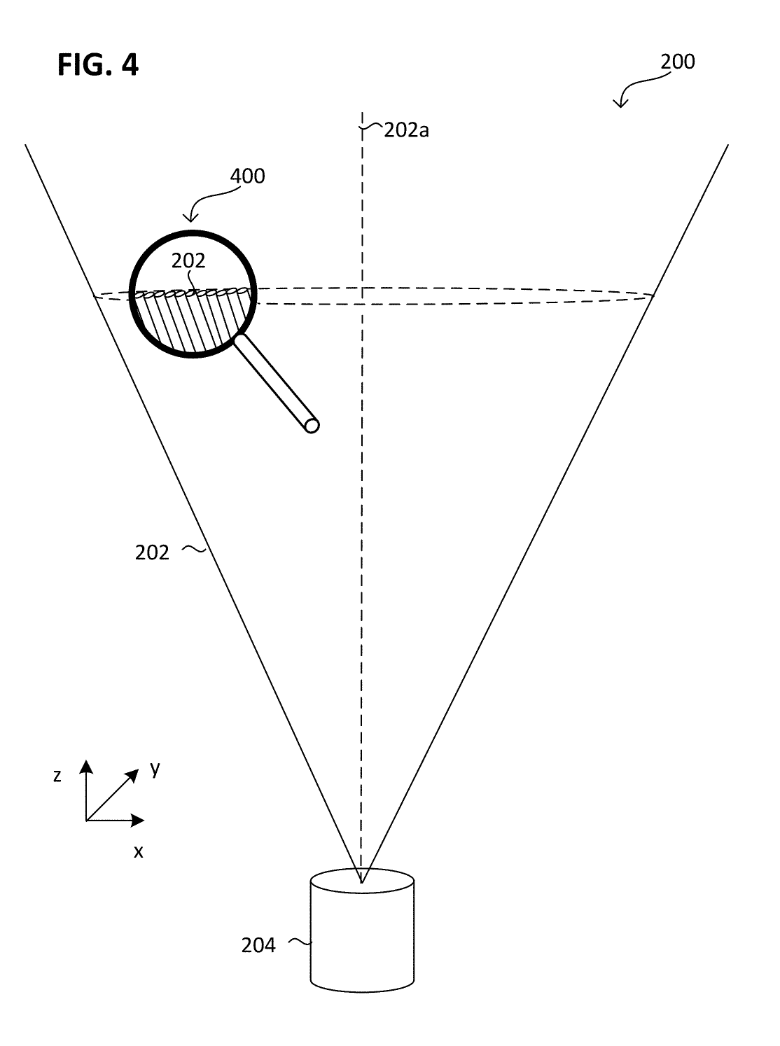

FIG. 4 illustrates the method 100 from view 200 in a schematic detailed view 400 according to various embodiments. For example, the line-shaped emission characteristic may be provided by a plurality of single beams, each emitted by one optoelectronic emitter of the radiation source 204. Additionally or alternatively, the radiation of the, or of each, optoelectronic emitter may be split by the optical system into at least two beams. For example, the radiation source 204 may include or be formed from a plurality (e.g., an array) of line-beam laser diodes, line lasers or another array of optoelectronic emitters (which are tilted to each other), e.g., a flabelliform and/or lamellate array of optoelectronic emitters.

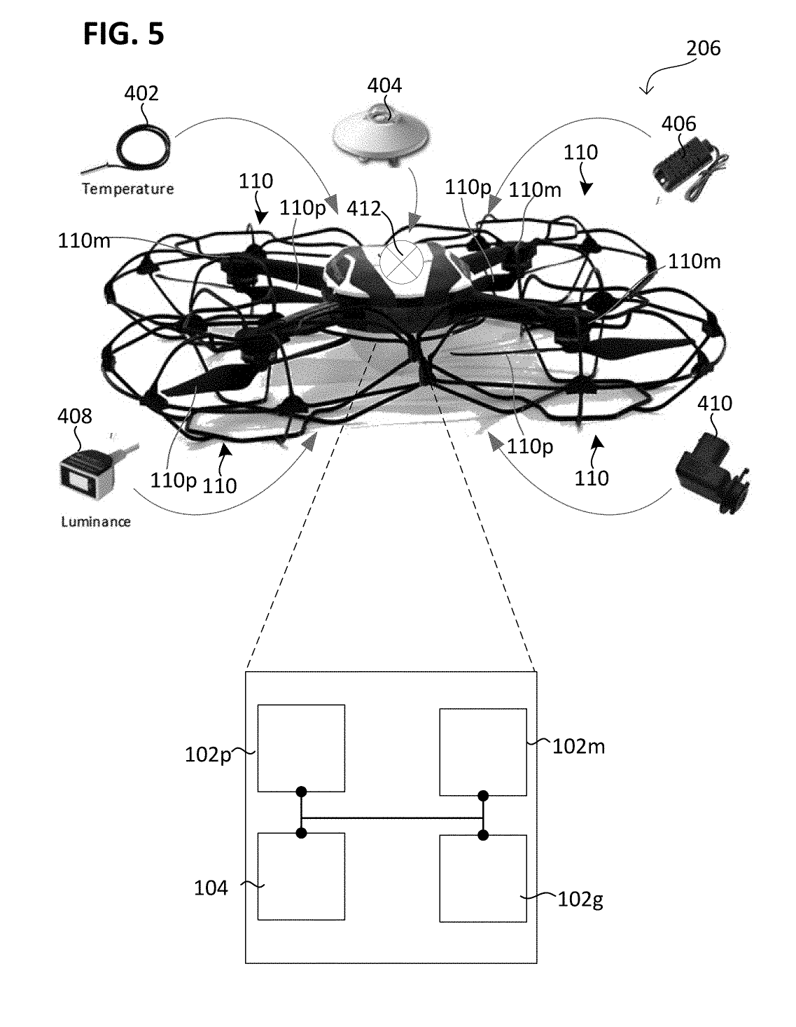

FIG. 5 illustrates an UAV 206 in a schematic perspective view according to various embodiments.

The UAV 206 may include a plurality of (e.g., three or more than three, e.g., four, six, eight, etc.) vehicle drive arrangements 110. Each of the vehicle drive arrangements 110 may include at least one drive motor 110m and at least one propeller 110p coupled to the at least one drive motor 110m. The one or more drive motors 110m of the UAV 206 may be electric drive motors.

Further, the UAV 206 may include one or more processors 102p (e.g., processing unit 102p) configured to control flight or any other operation of the UAV 206 including but not limited to navigation, image analysis, position calculation, and any method or action described herein. One or more of the processors 102p may be part of a flight controller or may implement a flight controller. The one or more processors 102p may be configured, for example, to provide a flight path based at least on an actual position of the UAV 206 and a desired target positon (e.g., the position of the at least one stationary sensor 204) for the UAV 206. In some aspects, the one or more processors 102p may control the UAV 206. In some aspects, the one or more processors 102p may directly control the drive motors 110m of the UAV 206, so that in this case no additional motor controller may be used. Alternatively, the one or more processors 102p may control the drive motors 110m of the UAV 206 via one or more additional motor controllers. The one or more processors 102p may include or may implement any type of controller suitable for controlling the desired functions of the UAV 206. The one or more processors 102p may be implemented by any kind of one or more logic circuits.

According to various aspects, the UAV 206 may include one or more memories 102m. The one or more memories may be implemented by any kind of one or more electronic storing entities, e.g., one or more volatile memories and/or one or more non-volatile memories. The one or more memories 102m may be used, e.g., in interaction with the one or more processors 102p, to build and/or store image data, navigation information, the inspection scheme, ideal positions, positional calculations, or alignment instructions. The one or more memories 102m may be used to store data representing the geolocation-based geo-fence. Additionally or alternatively, the one or more memories 102m may be used to store code segments, which when executed be one or more of the processors 102p initiate an alert sequence, e.g., a landing sequence and/or a light emission sequence.

Further, the UAV 206 may include one or more power supplies 104. The one or more power supplies 104 may include any suitable type of power supply, e.g., a directed current (DC) power supply. A DC power supply may include one or more batteries (e.g., one or more rechargeable batteries), etc.

According to various aspects, the UAV 206 may include one or more sensors 208 (also referred as to onboard sensors 208). The one or more sensors 208 may be configured to monitor a vicinity of the UAV 206. The one or more sensors 208 may be configured to detect obstacles in the vicinity of the UAV 206. The one or more sensors 208 may include, for example, one or more cameras (e.g., a depth camera, a stereo camera, a thermal imaging camera, etc.), one or more ultrasonic sensors, etc. The UAV 206 may further include a position detection system 102g. The position detection system 102g may be based, for example, on Global Positioning System (GPS) or any other available positioning system. Therefore, the one or more processors 102p may be further configured to modify the flight path of the UAV 206 based on data obtained from the position detection system 102g. The sensors 208 may be mounted as depicted herein, or in any other configuration suitable for an implementation.

According to various aspects, the one or more processors 102p may include at least one transceiver configured to provide an uplink transmission and/or downlink reception of radio signals including data, e.g., video or image data and/or commands. The at least one transceiver may include a radio frequency (RF) transmitter and/or a radio frequency (RF) receiver.

The one or more processors 102p may further include an inertial measurement unit (IMU) and/or a compass unit. The inertial measurement unit may allow, for example, a calibration of the UAV 206 regarding a predefined plane in a coordinate system, e.g., to determine the roll and pitch angle of the UAV 206 with respect to the gravity vector (e.g., from planet earth). Thus, an orientation of the UAV 206 in a coordinate system may be determined. The orientation of the UAV 206 may be calibrated using the inertial measurement unit before the UAV 206 is operated in flight modus. However, any other suitable function for navigation of the UAV 206, e.g., for determining a position, a flight velocity, a flight direction, etc., may be implemented in the one or more processors 102p and/or in additional components coupled to the one or more processors 102p.

The UAV 206 may further include at least one (in other words, one or more than one) light source 412. The at least one light source 412 may be configured to emit visible light having at least 10 W (Watt), e.g., having at least 25 W, e.g., having at least 50 W, e.g., having at least 75 W, e.g., having at least 100 W.

The one or more sensors 208 include at least one optoelectronic sensor 404 (e.g., an optoelectronic receiver 404 or optoelectronic transceiver 404). Optionally, the one or more sensors 208 may include at least one humidity sensor 406 (e.g., steam sensor), at least one temperature sensor 402 and/or at least one luminance sensor 408. Optionally, the one or more sensors 208 may include at least one pollution sensor 410 (e.g., air pollution and/or water pollution) and/or at least one chemical composition sensor 410.

The at least one optoelectronic sensor 404 may be configured to sense the beam 202 of radiation, e.g., sensible for the wavelength of the beam 202, e.g., for a wavelength in the range between 1 millimeters and 0.01 nanometers. In other words, the at least one optoelectronic sensor 404 may be configured to sense a wavelength with which the alert command is emitted.

The at least one optoelectronic sensor 404 may include or be formed from at least one photoelectric or photovoltaic receiver, e.g., at least one photodiode, at least one phototransistor, at least one photomultiplier, at least one optoisolator and/or at least one integrated optical circuit (IOC). Additionally or alternatively, the at least one optoelectronic sensor 404 may include or be formed from at least one photoconductive sensor, e.g., at least one photoresistor, at least one photoconductive camera tube and/or at least one charge-coupled imaging device. The at least one optoelectronic receiver 404 may optionally include a demodulator configured to demodulate the received beam 202 of radiation. By demodulation, the alert command may be extracted from the received beam 202 of radiation.

The UAV 206 may be configured to initiate the at least one alert sequence in response of receiving the alert command. For example, the UAV 206 may include code segments, e.g., stored in the one or more memories 102m, which are configured (e.g., when executed by the one or more processors 102p) to conduct the at least one alert sequence. The one or more processors 102p may be configured to control the at least one drive motor 110m and/or the at least one light source 412 of the UAV 206, e.g., in accordance with the at least one alert sequence.

The at least one alert sequence may include a landing sequence and/or a light emission sequence. The landing sequence may be configured to bring the UAV 206 to land 621 or to discontinue flight 621.

For example, the landing sequence may be configured to stop all motors 110m (also referred as to motor-stop configuration). Stopping all motors 110m may be understood as disconnecting each motor 110m of the plurality of vehicle drive arrangements 110 from power supply (e.g., to enable free rotation) or as blocking the rotation of each motor 110m of the plurality of vehicle drive arrangements 110.

In the motor-stop configuration, the UAV 206 may fall down, e.g., to enable a fast discontinuation of flight and/or to maximize its descent velocity. Additionally or alternatively, the landing sequence may be configured to stabilize the orientation of UAV 206, e.g., aligning the rotation axis of the at least one propeller 110p to a horizontal direction or a vertical direction. The rotation axis aligned to the horizontal direction may provide a minimum drag (also referred as to air friction) to further increase the descent velocity. The rotation axis aligned to the vertical direction may provide a maximum drag to minimize an intensity of impact (e.g., to ground). Alternatively to the motor-stop configuration, the landing sequence may be configured to return the UAV 206 to a predefined position (also referred as to return-home configuration). The predefined position may be, for example, any position within the geo-fenced region, e.g., within the geolocation-based geo-fence, as described later. Additionally or alternatively, the predefined position may be a position in fixed relation to the radiation source 204. Additionally or alternatively to the return-home configuration, the landing sequence may be configured to control a descent speed. For example, the plurality of vehicle drive arrangements 110 may be used to limit the descent speed to a predefined threshold or increase the descent speed above a predefined threshold.

The light emission sequence may enable the at least one (e.g., all) light source 412 of the UAV 206 to emit pulsed or sustained light, e.g., with a maximum of its power capability. Various light emission sequences may be implemented, e.g., emitting periodically pulsed red light, periodically changing the color of light between the pulses, or the like.

The at least one alert sequence may bring the unmanned aerial vehicle to ignore all remaining or further (e.g., received) commands during the at least one alert, e.g., during the landing sequence. For example, the at least one alert sequence may be ended automatically after a predefined period (e.g., several minutes or tens of minutes) or in response of the UAV 206 detecting the flight is discontinued, e.g., it touched the floor/ground or no further movement of the UAV 206 is detected. For example, ending the at least one alert sequence may bring the UAV 206 to accept (e.g., process) all remaining or further (e.g., received) commands.

To ignore all remaining or further (e.g., received) commands may be understood as the at least one alert sequence having the maximum processing priority, e.g., such that all remaining commands are suspended and/or all further commands are queued. Additionally or alternatively, initiating the at least one alert sequence may cancel all remaining or further (e.g., received) commands.

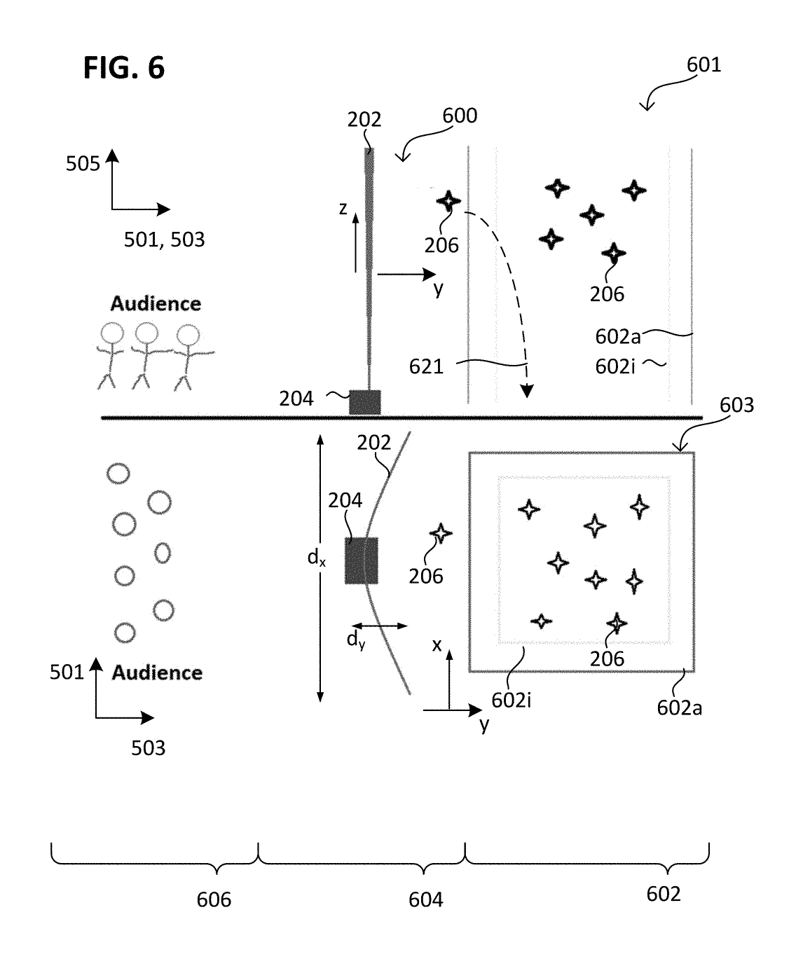

FIG. 6 illustrates the method 100 in a schematic side view 601 and top view 603 according to various embodiments. The method 100 may be carried out by a system 600 according to various embodiments.

The system 600 may include one or more than one radiation source 204, for example, a plurality of the radiation sources 204. For example, the plurality of the radiation sources 204 may be disposed separated from each other. For example, each radiation source 204 of the one or more than one radiation source 204 may provide one beam-based geo-fence.

The or each radiation source 204 of the one or more than one radiation source 204 may include or be formed from at least one stationary optoelectronic emitter. The at least one stationary optoelectronic emitter may be configured to repeatedly emit the alert command into a z-direction (also referred as to beam direction z) having a vertical component 505, e.g., into the vertical direction 505. For example, the at least one stationary optoelectronic emitter may be configured to emit the alert command several times per second, e.g., about 10 (e.g., 100, 1000, 10⁴ or 10⁵) times per second or more.

The vertical direction 505 or vertical component may be understood as being parallel to a direction of gravitational force, or in other words, the gravity vector. The or each horizontal direction 501, 503 or a horizontal component may be understood as being perpendicular to the gravity vector.

The or each radiation source 204 may have a line-beam emission characteristic for emitting the alert command. In other words, the alert command may be emitted in accordance with the line-shaped emission characteristic. For example, the line-shaped emission characteristic may provide a first beam extension (dₓ) along a first cross sectional direction x and a second beam extension (d_{y}) along a second cross sectional direction y of the beam 202. The first cross sectional direction x and the second cross sectional direction y may be perpendicular to each other and/or to the emission direction z.

The first beam extension (dₓ) may be different from (e.g., more than) the second beam extension (d_{y}). In other words, a ratio of the first beam extension (dₓ) to the second beam extension (d_{y}) may be different from one, e.g., greater than about 100, 1000, 10⁴, 10⁵ or more. Additionally or alternatively, the second beam extension (d_{y}) may be less than about 1 m (e.g., less than about 0.5 m, 0.25 m, 10⁻¹ m) and/or the first beam extension (dₓ) may be more than about 10 m (e.g., more than about 50 m, 10 m (e.g., 1000 m, 10⁴ m, 10⁵ m) or more. For example, the first beam extension (dₓ) and the second beam extension (d_{y}) may be measured within a distance from the respective radiation source 204 in which the power density of the beam 202 is above about 1 mW/cm² (Milliwatt per square centimeter), e.g., of above about 2.5 mW/cm², e.g., of above about 5 mW/cm².

In general, an angle between the beam direction z and the vertical direction 505 may be less than about 90°. For example, the vertical component of the beam direction z may be greater than the horizontal component of the beam direction z. For example, the angle between the beam direction z and the vertical direction 505 may be less than about 45°, e.g., less than about 35°, e.g., less than about 25°, e.g., less than about 15°, e.g., less than about 5°.

The system 600 may further include one or more than one UAV 206, e.g., a plurality of UAV 206 (e.g., forming a swarm). The one or more than one UAV 206 may optionally be operatively connected to each other and/or to a stationary control center (e.g., by radio communication). For example, the one or more than one UAV 206 may be configured to implement a synchronized flight sequence, e.g., may be configured to arrange each other according to a predetermined (2D or 3D) pattern. Additionally or alternatively, the one or more than one UAV 206 may be configured to perform a light show sequence, e.g., synchronized to each other.

The geo-fence beam 202 may separate a geo-fenced region 602 from a protected region 606. For example, the geo-fence beam 202 may be disposed in an alert region 604 disposed between the geo-fenced region 602 and the protected region 606. Illustratively, the protected region 606 may include fragile living objects, for example, an audience.

Optionally, the system 600 may be configured to implement a geolocation-based geo-fence 602i, 602a (e.g., positioning-based geo-fence 602), e.g., within the geo-fenced region 602 or substantially identical to the perimeter of the geo-fenced region 602. For example, the one or more than one UAV 206 may include data defining the position, orientation and/or shape of the geolocation-based geo-fence 602i, 602a in three-dimensional space. For example, the geolocation-based geo-fence 602i, 602a may be GPS-based (also referred as to GPS-fence) or based on another positioning system as described above.

Optionally, the geolocation-based geo-fence 602i, 602a may implement a multiple level geo-fence 602i, 602a, including at least one inner geo-fence 602i and at least one outer geo-fence 602a. The outer geo-fence 602a may surround the inner geo-fence 602i. The one or more than one UAV 206 may be configured to set a flight course in response of passing the inner geo-fence 602i, wherein the flight course may be directed into the region surrounded by the inner geo-fence 602i. The one or more than one UAV 206 may be configured to initiate the landing sequence in response of passing the outer geo-fence 602a. However, in case of positional malfunction, e.g., multipath misplacement or total signal loss, the UAV 206 may fail on recognizing the geolocation-based geo-fence 602i, 602a.

For this case, the geo-fence beam 202 may provide for an additional security level, e.g., independent from any geolocational service, positional calculations, navigation information or the like. The one or more than one UAV 206 may be configured to implement the at least one alert sequence in response to passing the geo-fence beam 202. For example, an UAV 206 passing the geo-fence beam 202 may receive the alert command. In response to receiving the alert command, the landing sequence may be initiated.

In an illustrative example, an UAV 206 (e.g., a drone) is equipped with a high-speed and/or high-power IR-transceiver 404 that may be configured to transmit and/or receive data, e.g., before flight. In connection with the geo-fence beam 202, the IR-transceiver 404 may be in an operative mode during in flight. The infrared fence system 204 (IR-fence 204) may include one or more high-power directional IR-transmitters (e.g., IR-Line-Laser) that constantly send a “motors-off” of “emergency-land” command. Each UAV 206 of the one or more than one UAV 206 that passes the geo-fence IR-beam 202 may come down immediately, without any further propagation towards the protected region 606.

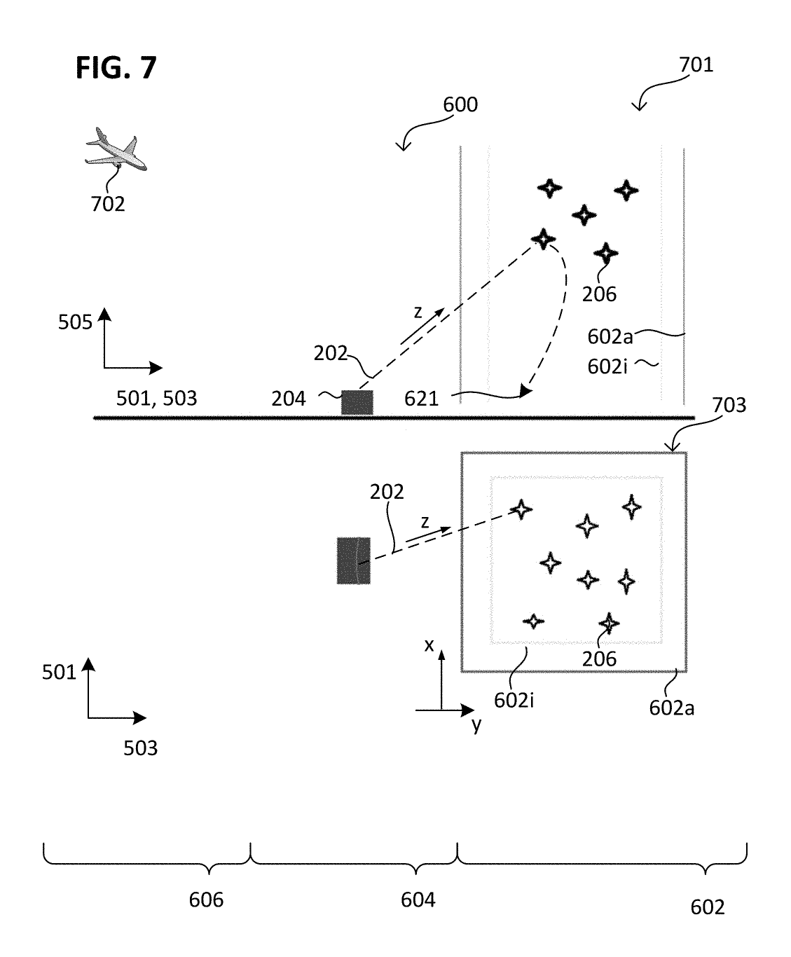

FIG. 7 illustrates the method 100 in a schematic side view 701 and top view 703 according to various embodiments. The method 100 may be carried out by the system 600 according to various embodiments.

Additionally or alternatively to the geo-fence beam 202, the UAV 206 as configured to initiate the alert sequence may be adapted to “take out” a single UAV 206 from a swarm (e.g., fleet) including a plurality of UAVs instructing, or bring down the whole swarm, e.g., in a radio-less emergency. The swarm may be understood as a plurality of UAVs 206, which implement a correlated flight sequence, e.g., by sensing each other and/or communicating with each other (e.g., exchanging data).

For example, a circuit (e.g., implemented in the radiation source 204 and/or in a separate computing unit) may be configured to emit an alert command into the geo-fenced region 602 in response to detecting the aerial vehicle 702. For example, the circuit may include one or more than one processor and an interface configured to receive a signal indicating the aerial vehicle 702 approaching the geo-fenced region 602. Optionally, the circuit may be connected to a sensor (e.g., radar or the like) configured to detect the aerial vehicle 702 approaching the geo-fenced region 602 (from outside the geo-fenced region 602). Additionally or alternatively, the detection may be received from a local or global flight monitoring service.

In this configuration, the alert command may not necessarily be emitted with the line-shaped emission characteristic. The emission characteristic may be different from line-shaped, e.g., being circular shaped or square-shaped.

For example, the emission characteristic may be configured to selectively transmit the alert command to one or more than one UAV 206 (e.g., using a narrow emission characteristic). In this case, the circuit may be configured to emit the alert command directed towards the one or more than one UAV 206. Optionally, the circuit may be configured to sense the positional status of each UAV 206 of the one or more than one UAV 206, of each UAV 206 in the geo-fenced region 602, e.g., of each UAV 206 of the swarm.

For example, the narrow emission characteristic may provide for the first beam divergence (Θₓ) and the second beam divergence (Θ_{y}) differing less than 50% from each other. In other words, a ratio of the first beam divergence (Θₓ) to the second beam divergence (Θ_{y}) may be less than about 1.5, e.g., less than about 1.25, 1.1 or less. Additionally or alternatively, the narrow emission characteristic may provide for the first beam divergence (Θₓ) and the second beam divergence (Θ_{y}) to be less than about 1° (e.g., less than about 0.5°, 0.25°, 10⁻¹⁰°, 10⁻²°, 10⁻³° or less).

The narrow emission characteristic may provide for selectively instructing at least one UAV 206 to initiate the alert sequence. For example, only those UAVs 206 flying in a predefined height range, e.g., too high or too low, may be instructed to initiate the at least one alert sequence.

Optionally, the emission of the alert command and/or the detection of the aerial vehicle 702 (also referred as to foreign aerial vehicle) may be fully automated, e.g., by using one or more than one processor. Alternatively, a person, e.g., an operator, may conduct the emission of the alert command and/or the detection of the aerial vehicle 702.

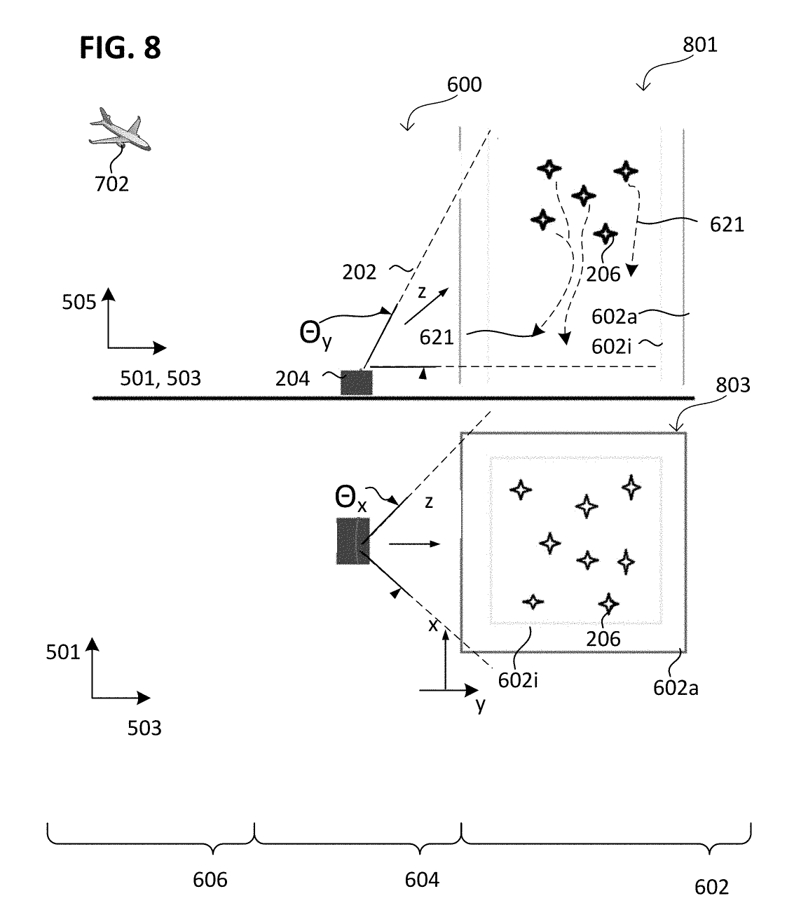

FIG. 8 illustrates the method 100 in a schematic side view 801 and top view 803 according to various embodiments. The method 100 may be carried out by the system 600 according to various embodiments similar as described regarding FIG. 7.

Alternatively to the narrow emission characteristic, the emission characteristic may be configured to transmit the alert command to each UAV 206 in the geo-fenced region 602 (also referred as to widespread emission characteristic). For example, the beam 202 may completely overlap a geo-fenced region 602.

For example, the widespread emission characteristic may provide for the first beam divergence (Θₓ) and the second beam divergence (Θ_{y}) differing less than 50% from each other. In other words, a ratio of the first beam divergence (Θₓ) to the second beam divergence (Θ_{y}) may be less than about 1.5, e.g., less than about 1.25, 1.1, or less. Additionally or alternatively, the widespread emission characteristic may provide for the first beam divergence (Θₓ) and the second beam divergence (Θ_{y}) to be more than about 10° (e.g., more than about 30°, 45°, 60°, 90°, 120°, 150° or more, e.g., about 180°).

Optionally, the emission of the alert command and/or the detection of the aerial vehicle 702 (also referred as to foreign aerial vehicle) may be fully automated, e.g., by using one or more than one processor. Alternatively, a person, e.g., an operator, may conduct the emission of the alert command and/or the detection of the aerial vehicle 702.

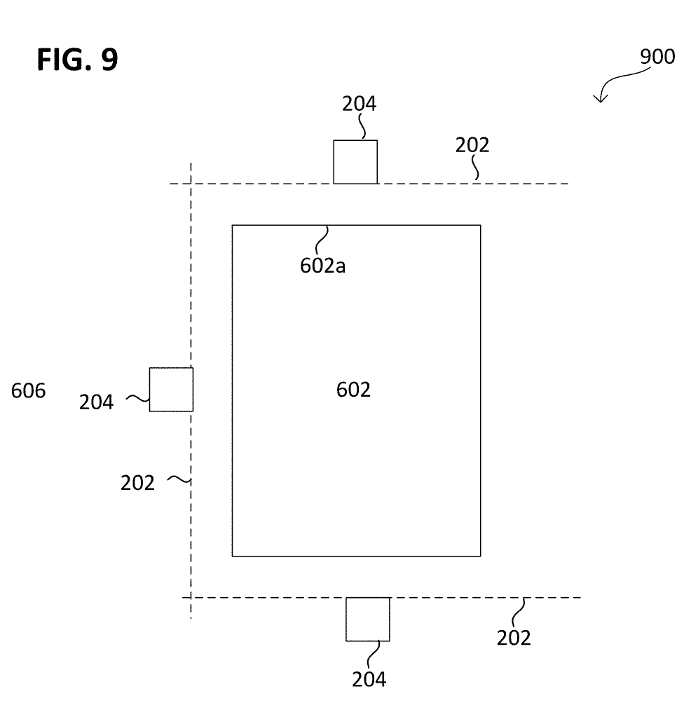

FIG. 9 illustrates the method 100 in a schematic top view 900 according to various embodiments. According to various embodiments, the system 600 includes a plurality of radiation sources 204 (each including at least one stationary optoelectronic emitter) surrounding a geo-fenced region 602. For example, the geo-fenced region 602 may be disposed between at least two beams 202 and/or at least two radiation sources 204 of the plurality of radiation sources 204.

One or more than one radiation source of the plurality of radiation sources 204 may perform the alert emission 901 into and/or outside of (e.g., past) the geo-fenced region 602. The alert command may be emitted into the geo-fenced region 602 with the widespread emission characteristic and/or the narrow emission characteristic. The alert command may be emitted distant to the geo-fenced region 602 with the line-beam emission characteristic and/or the narrow emission characteristic.

For example, each radiation source 204 of the plurality of radiation sources 204 may repeatedly emit the alert command (alert emission 901) with the line-beam emission characteristic, e.g., by emitting a line-shaped beam 202. The alert emission 901 may be performed in response to or as long as at least one UAV 206 is detected to fly in the geo-fenced region 602.

Additionally or alternatively, at least one radiation source 204 of the plurality of radiation sources 204 may emit the alert command into the geo-fenced region 602 in response to the intruder detection 909.

Optionally, the plurality of radiation sources 204 and/or the plurality of line-shaped beams 202 may be disposed equidistant from the geo-fenced region 602. The line-shaped beams 202 may optionally overlap each other (illustratively, proximate the corners of the geo-fenced region 602).

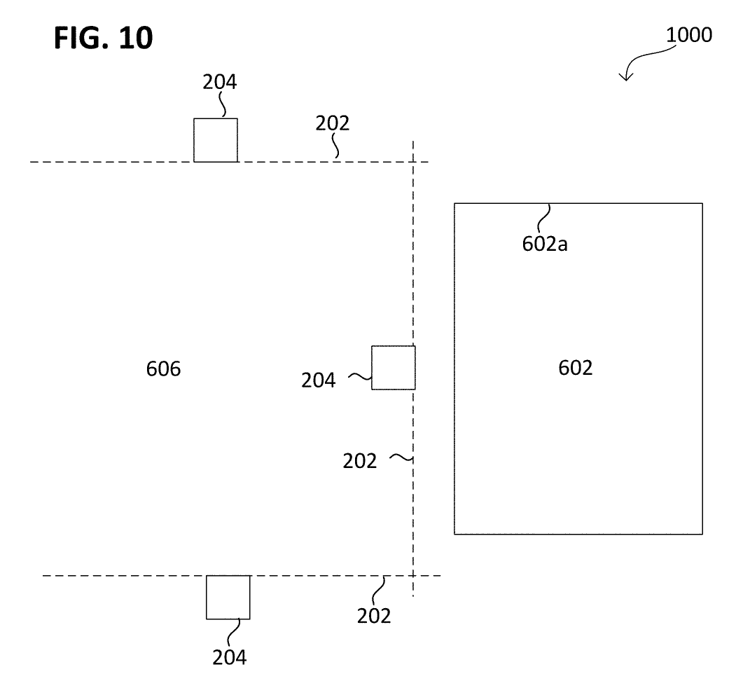

FIG. 10 illustrates the method 100 in a schematic top view 1000 according to various embodiments. According to various embodiments, the system 600 includes a plurality of radiation sources 204 (each including at least one stationary optoelectronic emitter) surrounding a geo-fenced region 602. The beams 202 may optionally overlap each other (illustratively, proximate the corners of the protected region 606). For example, the protected region 606 may be disposed between at least two beams 202 and/or at least two radiation sources 204 of the plurality of radiation sources 204.

One or more than one radiation source of the plurality of radiation sources 204 may perform the alert emission 1001 into and/or distant to (e.g., past) the geo-fenced region 602 as described regarding FIG. 9.

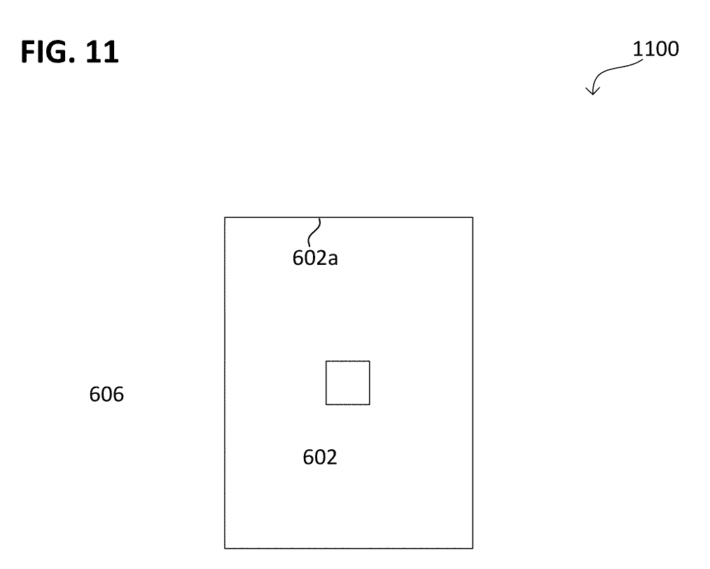

FIG. 11 illustrates the method 100 in a schematic top view 1100 according to various embodiments. According to various embodiments, the system 600 includes at least one radiation source 204 (each including at least one stationary optoelectronic emitter) disposed within or below the geo-fenced region 602.

One or more than one radiation source of the plurality of radiation sources 204 may perform the alert emission 1101 into and/or distant to (e.g., past) the geo-fenced region 602 as described regarding FIG. 9. For example, the at least one radiation source 204 may be configured to emit the alert command into a substantially vertical direction 105 and/or from below the geo-fenced region 602 into the geo-fenced region 602, e.g., in response to the intruder detection 1109. Additionally or alternatively, the at least one radiation source 204 may be configured to emit the alert command into a substantially horizontal direction 105 and/or from below the geo-fenced region 602 distant to the geo-fenced region 602. In this configuration, the at least one radiation source 204 may limit the geo-fenced region 602 at its bottom. For example, a pyramidal or cone shaped geo-fenced region 602 may be provided having its apex directed towards the at least one radiation source 204.

Further, various embodiments will be described in the following.

Example 1 is a method 100, including: detecting 109 an aerial vehicle 702 approaching a geo-fenced region 602 from outside the geo-fenced region 602 (in other words the aerial vehicle 702 approaches the geo-fenced region 602 from outside the geo-fenced region 602); at least one optoelectronic emitter emitting 101 an alert command into the geo-fenced region 602 in response to detecting the aerial vehicle 702; an optoelectronic sensor 404 of an unmanned aerial vehicle 206 (UAV 206) flying in the geo-fenced region 602 receiving 103 the alert command; the unmanned aerial vehicle 206 initiating 105, 107 at least one of the following sequences in response to receiving the alert command: a landing sequence bringing the unmanned aerial vehicle 206 to land 621 or to discontinue flight 621; or a light emission sequence of pulsed or sustained light.

Example 2 is the method 100 of example 1, wherein the aerial vehicle 702 is a manned aerial vehicle (e.g., a plane).

Example 3 is the method 100 of one of the examples 1 or 2, wherein the aerial vehicle 702 is at least one of larger of heavier than the unmanned aerial vehicle 206, e.g., by at least about 100% (e.g., 250%, 500%, 1000% or by a factor of 100, 1000, 10⁴ or 10⁵).

Example 4 is the method 100 of one of the examples 1 to 3, wherein the aerial vehicle 702 flies through or passes the geo-fenced region 602.

Example 5 is the method 100 of one of the examples 1 to 4, wherein the aerial vehicle 702 has a flight velocity of more than the unmanned aerial vehicle 206, e.g., by at least about 100% (e.g., 250%, 500%, 1000% or by a factor of 100, 1000, 10⁴ or 10⁵).

Example 6 is the method 100 of one of the examples 1 to 5, further including: operating and/or powering one or more than one (e.g., each) light source 412 of the unmanned aerial vehicle 206 according to the light emission sequence.

Example 7 is a method 100, including: at least one stationary optoelectronic emitter repeatedly emitting 101 an alert command with a line-beam emission characteristic into a direction having a vertical component, an optoelectronic sensor 404 of a flying unmanned aerial vehicle 206 receiving 103 the alert command from the stationary optoelectronic emitter; the unmanned aerial vehicle 206 initiating 105 a landing sequence in response to receiving the alert command, wherein the landing sequence brings the unmanned aerial vehicle 206 to land 621 or to discontinue flight 621.

Example 8 is the method 100 of one of the examples 1 to 7, wherein one or more than one processor perform the detection of the aerial vehicle and/or control the at least one optoelectronic emitter.

Example 9 is the method 100 of one of the examples 1 to 8, wherein one or more than one processor initiate the emission of the alert command.

Example 10 is the method 100 of one of the examples 1 or 9, wherein the at least one stationary optoelectronic emitter includes or is formed from at least one solid-state light source.

Example 11 is the method 100 of one of the examples 1 or 10, wherein the at least one stationary optoelectronic emitter includes or is formed from at least one light emitting diode.

Example 12 is the method 100 of one of the examples 1 to 11, wherein the at least one stationary optoelectronic emitter includes at least one semiconductor laser.

Example 13 is the method 100 of one of the examples 1 or 12, wherein the at least one stationary optoelectronic emitter includes or is formed from at least one organic light emitting diode.

Example 14 is the method 100 of one of the examples 1 or 13, wherein the at least one stationary optoelectronic emitter includes or is formed from at least one semiconductor light source.

Example 15 is the method 100 of one of the examples 1 or 14, wherein the at least one stationary optoelectronic emitter is configured to emit radiation modulated with the alert command.

Example 16 is the method 100 of one of the examples 1 or 15, wherein the at least one stationary optoelectronic emitter is configured to emit radiation having a wavelength in the range between 1 millimeters and 0.01 nanometers.

Example 17 is the method 100 of one of the examples 1 or 16, wherein the at least one stationary optoelectronic emitter includes or is formed from an infrared emitter.

Example 18 is the method 100 of one of the examples 1 or 17, wherein the at least one stationary optoelectronic emitter repeatedly emitting the alert command multiple per second and/or during a period of more than about 5 (e.g., 10, 60 or 300) minutes.

Example 19 is the method 100 of one of the examples 1 or 18, wherein the at least one stationary optoelectronic emitter repeatedly emitting the alert command in response to or at least while the unmanned aerial vehicle 206 is operating (e.g., flying), e.g., in response to or at least while the unmanned aerial vehicle 206 is detected to operate (e.g., fly).

Example 20 is the method 100 of one of the examples 1 or 19, one or more than one optical component (e.g., lens, mirror, splitter, diffuser, prism, and the like) converting the emission of the at least one stationary optoelectronic emitter (e.g., having a non-line-beam emission characteristic) into the line-beam emission characteristic.

Example 21 is the method 100 of example 20, the at least one optical component of the one or more than one optical component oscillating to convert the emission into the line-beam emission characteristic (also referred as to dynamic conversation).

Example 22 is the method 100 of example 21 or 21, the or another at least one optical component of the one or more than one optical component including a static conversation characteristic (e.g., an astigmatic conversation characteristic) configured to convert the emission into the line-beam emission characteristic (also referred as to static conversation).

Example 23 is the method 100 of one of the examples 1 or 22, wherein the at least one stationary optoelectronic emitter includes at least one light source configured to emit light by stimulation (also referred as to stimulated emission).

Example 24 is the method 100 of one of the examples 1 or 23, wherein the at least one stationary optoelectronic emitter includes at least one laser (e.g., at least one line beam laser and/or at least one solid-state laser).

Example 25 is the method 100 of one of the examples 1 or 24, wherein the at least one stationary optoelectronic emitter includes at least one (e.g., visible and/or invisible) light emitter and/or at least one infrared emitter.

Example 26 is the method 100 of one of the examples 1 or 25, wherein the at least one stationary optoelectronic emitter includes a plurality of stationary optoelectronic emitters surrounding a geo-fenced region 602 (e.g., a GPS-fence, or other geolocation-based geo-fence).

Example 27 is the method 100 of one of the examples 1 or 26, wherein the unmanned aerial vehicle 206 includes data representing and/or defining a or the geo-fenced region 602 (e.g., a GPS-fence, or other geolocation-based geo-fence).

Example 28 is the method 100 of one of the examples 1 or 27, further including: the unmanned aerial vehicle 206 repeatedly determining and/or estimating its positional status regarding a or the geo-fenced region 602 (e.g., a GPS-fence, or other geolocation-based geo-fence).

Example 29 is the method 100 of examples 27 and 28, further including: the unmanned aerial vehicle 206 determining a flight path based on its positional status, wherein the flight path remains or leads into the geo-fenced region 602.

Example 30 is the method 100 of one of the examples 1 or 29, wherein the at least one stationary optoelectronic emits the alert command into a spatial region, which is isolated from and/or disturbed in radio communication.

Example 31 is the method 100 of one of the examples 1 or 30, wherein the at least one stationary optoelectronic emits the alert command into a spatial region, which is deactivated and/or jammed from radio communication.

Example 32 is the method 100 of one of the examples 1 or 31, wherein the landing sequence triggers the unmanned aerial vehicle 206 to perform at least one of the following: stop all motors; stabilize its orientation; return to a predefined position; or control a descent speed.

Example 33 is the method 100 of one of the examples 1 or 32, wherein the landing sequence brings the unmanned aerial vehicle 206 down, e.g., to ground or to floor.

Example 34 is the method 100 of one of the examples 1 or 33, wherein the landing sequence triggers the unmanned aerial vehicle 206 to sense its spatial (e.g., lateral) drift and counteract the spatial drift.

Example 35 is the method 100 of one of the examples 1 or 34, further including: determining a position for the at least one stationary optoelectronic emitter proximate to a or the geo-fenced region 602; and disposing at least one stationary optoelectronic emitter at the position.

Example 36 is the method 100 of one of the example 35, wherein determining the position includes one or a plurality of processors processing data, the data representing the geo-fenced region 602.

Example 37 is the method 100 of one of the examples 35 or 36, wherein determining the position includes determining an orientation of the line-beam emission characteristic having a tangential relationship to a boundary of the geo-fenced region 602; and disposing at least one stationary optoelectronic emitter in accordance with the orientation.

Example 38 is the method 100 of one of the examples 35 to 37, wherein determining the position includes determining an orientation of the line-beam emission characteristic being distant from the geo-fenced region 602; and disposing at least one stationary optoelectronic emitter in accordance with the orientation.

Example 39 is the method 100 of one of the examples 37 or 38, wherein the orientation is configured to avoid the line-beam emission characteristic intersecting with the boundary of the geo-fenced region 602.

Example 40 is the method 100 of one of the examples 1 or 39, further including: disposing at least one stationary optoelectronic emitter at distance from a or the geo-fenced region 602 (e.g., below or laterally adjacent), wherein the distance is less than an extension of the geo-fenced region 602 along the distance.

Example 41 is the method 100 of one of the examples 39 or 40, wherein the disposing includes: aligning the emission of the at least one stationary optoelectronic emitter to have a tangential relationship to a boundary of the geo-fenced region 602.

Example 42 is the method 100 of one of the examples 1 or 41, further including: providing a protected region adjacent a or the geo-fenced region 602; wherein the line-beam emission characteristic separates the protected region and the geo-fenced region 602.

Example 43 is the method 100 of example 42, wherein the protected region includes at least one person and/or more living organisms (e.g., persons) than the geo-fenced region.

Example 44 is the method 100 of one of the examples 1 to 43, the unmanned aerial vehicle 206 ignoring and/or canceling all remaining or further (e.g., received) commands during the landing sequence.

Example 45 is the method 100 of one of the examples 1 to 44, the unmanned aerial constantly descending during the landing sequence.

Example 46 is the method 100 of one of the examples 1 to 45, wherein the unmanned aerial vehicle 206 includes data representing the or a geo-fenced region 602.

Example 47 is the method 100 of one of the examples 1 to 46, further including: a plurality of (e.g., including at least 2, 5, 10, 25, 50 or 100) unmanned aerial vehicles 206 receiving the alert command parallel to each other (e.g., at substantially the same time), wherein the plurality of unmanned aerial vehicles 206 includes the unmanned aerial vehicle 206.

Example 48 is the method 100 of one of the examples 1 to 46, further including: a plurality of (e.g., including at least 2, 5, 10, 25, 50 or 100) unmanned aerial vehicles 206 sequentially receiving the alert command, wherein the plurality of unmanned aerial vehicles 206 includes the unmanned aerial vehicle 206.

Example 49 is the method 100 of one of the examples 1 to 48, further including: the or a plurality of unmanned aerial vehicles 206 performing a correlated flight sequence, wherein the plurality of unmanned aerial vehicles 206 includes the unmanned aerial vehicle 206 and/or the one further unmanned aerial vehicle 206.

Example 50 is the method 100 of example 49, wherein each unmanned aerial vehicle 206 of the plurality of unmanned aerial vehicles includes data representing the correlated flight sequence.

Example 51 is the method 100 of one of the examples 47 to 50, wherein each unmanned aerial vehicle 206 of the plurality of unmanned aerial vehicles 206 receives the alert command and initiates the at least one sequence (e.g., the landing sequence and/or the light emission sequence) in response to receiving the alert command.

Example 52 is the method 100 of one of the examples 1 to 51, the unmanned aerial vehicle 206 ignoring and/or canceling all remaining or further (e.g., received) commands during the at least one sequence (e.g., the landing sequence and/or the light emission sequence) in response to receiving the alert command.

Example 53 is the method 100 of one of the examples 1 to 52, wherein the light emission sequence brings the unmanned aerial vehicle 206 to send the alert command (e.g., a time-delayed copy thereof).

Example 54 is the method 100 of one of the examples 1 to 53, wherein the line-shaped emission characteristic defines a first emission divergence (Θₓ) and a second emission divergence (Θ_{y}) regarding the direction of the emission (also referred as to emission direction), wherein the first emission divergence (Θₓ)and the second emission divergence (Θ_{y}) are perpendicular to each other and have a ratio to each other of less than 10⁻¹ degree, 10⁻² degree or 10⁻³ degree.

Example 55 is a control circuit for an unmanned aerial vehicle 206, including: a first interface configured to control at least one of the following components of the unmanned aerial vehicle 206: at least one motor or at least one light source; a second interface configured to communicate with an optoelectronic sensor 404 of the unmanned aerial vehicle 206; one or a plurality of processors configured to implement at least one sequence of the following sequences via the first interface: a landing sequence bringing the unmanned aerial vehicle 206 to land 621 or to discontinue flight 621; or a light emission sequence of pulsed or permanent light; wherein the one or a plurality of processors are further configured to initiate the at least one sequence via the first interface in response to an alert command received via the second interface.

Example 56 is the control circuit of example 55, the one or a plurality of processors further configured to control the unmanned aerial vehicle 206 or its components according to the method 100 of one of the examples 1 to 54.

Example 57 is the control circuit of example 55 or 56, wherein the landing sequence triggers the unmanned aerial vehicle to perform at least one of the following: stop all motors; stabilize its orientation; return to a predefined position; or control a descent speed.

Example 58 is the control circuit of one of the examples 55 to 57, wherein at least one processor of the one or the plurality of processors is configured to instruct the unmanned aerial vehicle to ignore and/or cancel all remaining or further commands during the landing sequence.

Example 59 is the control circuit of one of the examples 55 to 58, further including one or more than one memory, wherein the memory stores data representing a geo-fenced region.

Example 60 is the control circuit of one of the examples 55 to 59, wherein at least one processor of the one or the plurality of processors is configured to process data representing a or the geo-fenced region.

Example 61 is the control circuit of example 59 or 60, wherein at least one processor of the one or the plurality of processors is configured to repeatedly determine a positional status of the unmanned aerial vehicle regarding the geo-fenced region.

Example 62 is the control circuit of one of the examples 59 to 61, wherein at least one processor of the one or the plurality of processors is configured to determine a flight path based on its positional status, wherein the flight path remains or leads into the geo-fenced region.

Example 63 is the control circuit of one of the examples 55 to 62, wherein at least one processor of the one or the plurality of processors is configured to operate one or more than one light source of the unmanned aerial vehicle according to the light emission sequence.

Example 64 is the control circuit of one of the examples 55 to 63, wherein the landing sequence triggers the unmanned aerial vehicle 206 to perform at least one of the following: stop all motors; stabilize its orientation; return to a predefined position; or control a descent speed.

Example 65 is an unmanned aerial vehicle 206, including: the control circuit according to one of the examples 55 to 64; and at least one motor or at least one light source in communicative connection to the first interface; an optoelectronic sensor 404 (e.g., at least one photodetector or photodiode) in communicative connection to the second interface.

Example 66 is the unmanned aerial vehicle of example 65, wherein the optoelectronic sensor 404 includes at least one photoconductive, photoelectric or photovoltaic sensor.

Example 67 is a system, including: at least one stationary optoelectronic emitter configured to repeatedly emit an alert command with a line-beam emission characteristic into a direction having a vertical component; at least one unmanned aerial vehicle 206 including an optoelectronic sensor 404; wherein the unmanned aerial vehicle 206 is configured to implement at least one sequence of the following sequences via the first interface: a landing sequence bringing the unmanned aerial vehicle 206 to land 621 or to discontinue flight 621; or a light emission sequence of pulsed or sustained light; wherein the unmanned aerial vehicle 206 is further configured to initiate the at least one sequence in response to the alert command received via the optoelectronic sensor 404.

Example 68 is the system of example 67, wherein the optoelectronic sensor 404 includes at least one photoconductive, photoelectric or photovoltaic sensor.

Example 69 is the system of example 67or 68, wherein the at least one stationary optoelectronic emitter comprises at least one solid-state light source.

Example 70 is the system of one of the examples 67 to 69, wherein the at least one stationary optoelectronic emitter comprises at least one laser.

Example 71 is the system of one of the examples 67 to 70, wherein the at least one stationary optoelectronic emitter comprises at least one infrared emitter.

Example 72 is the system of one of the examples 67 to 71, wherein the line-shaped emission characteristic defines a first emission divergence and a second emission divergence regarding the direction of the emission, wherein the first emission divergence and the second beam divergence are perpendicular to each other and have a ratio to each other of less than 10⁻¹.

Example 73 is the system of one of the examples 67 to 72, wherein the at least one stationary optoelectronic emitter is configured to emit the alert command into a spatial region, which is isolated from and/or disturbed in radio communication.

Example 74 is the system of one of the examples 67 to 73, wherein the at least one stationary optoelectronic emitter is configured to repeatedly emit the alert command in response to the unmanned aerial vehicle flying or at least while the unmanned aerial vehicle is flying.

Example 75 is the system of one of the examples 67 to 74, wherein the unmanned aerial vehicle includes (e.g., stores, e.g., on its one or more than one memory) data representing a geo-fenced region.

Example 76 is the system of example 75, wherein the line-beam emission characteristic separates a protected region and the geo-fenced region, wherein the protected region includes at least one person and/or includes more persons than the geo-fenced region.

Example 77 is the system of example 75 or 76, wherein the at least one stationary optoelectronic emitter includes a plurality of stationary optoelectronic emitters surrounding the geo-fenced region.

Example 78 is a controlling means for an unmanned aerial vehicle 206, including: a first interface means configured for controlling at least one of the following components of the unmanned aerial vehicle 206: at least one motor means or at least one light emitting means; a second interface means configured for communicating with an optoelectronic sensing means 404 of the unmanned aerial vehicle 206; one or a plurality of processing means configured for implementing at least one sequence of the following sequences via the first interface means: a landing sequence bringing the unmanned aerial vehicle 206 to land 621 or to discontinue flight 621; or a light emission sequence of pulsed or permanent light; wherein the one or a plurality of processing means are further configured for initiating the at least one sequence via the first interface means in response to an alert command received via the second interface means.

Example 79 is the controlling means of example 78, the one or a plurality of processing means further configured for controlling the unmanned aerial vehicle 206 or its components according to the method 100 of one of the examples 1 to 54.

Example 80 is an unmanned aerial vehicle 206, including: the controlling means according to Example 78 or 79; and at least one motor means or at least one light emitting means in communicative connection to the first interface means; an optoelectronic sensing means 404 in communicative connection to the second interface means.

Example 81 is s system, including: at least one stationary optoelectronic emitting means configured for repeatedly emitting an alert command with a line-beam emission characteristic into a direction having a vertical component; at least one unmanned aerial vehicle 206 including an optoelectronic sensing means 404; wherein the unmanned aerial vehicle 206 is configured for implementing at least one sequence of the following sequences: a landing sequence bringing the unmanned aerial vehicle 206 to land 621 or to discontinue flight 621, or a light emission sequence of pulsed or sustained light; wherein the unmanned aerial vehicle 206 is further configured to initiate the at least one sequence in response to the alert command received via the optoelectronic sensing means 404.

Example 82 is the system of example 81, wherein the optoelectronic sensing means 404 includes at least one photoconductive, photoelectric or photovoltaic sensing means.

Example 83 is a non-transient computer readable medium including code segments configured, when executed by one or more than one processors, to perform the method 100 of one of the examples 1 to 54.

Example 84 is a (e.g., non-transient) computer-readable medium storing instructions, when executed by a processor, implementing the method 100 of one of the examples 1 to 54.

Example 85 is one or more than one processor configured to perform the method 100 of one of the examples 1 to 54.

Example 86 is one of the examples 1 to 85 configured for emergency operation.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A control circuit for an unmanned aerial vehicle, comprising:
a first interface configured to control at least one of the following components of the unmanned aerial vehicle: a motor or a light source;
a second interface configured to communicate with an optoelectronic sensor of the unmanned aerial vehicle;
one or a plurality of processors configured to implement at least one sequence of the following sequences via the first interface:
a landing sequence bringing the unmanned aerial vehicle to land or to discontinue flight; or
a light emission sequence of pulsed or permanent light;
wherein the one or a plurality of processors are further configured to initiate the at least one sequence via the first interface in response to an alert command received via the second interface.

2. The circuit of claim 1, wherein the landing sequence triggers the unmanned aerial vehicle to perform at least one of the following:
stop all motors;
stabilize its orientation;
return to a predefined position; or
control a descent speed.

3. The circuit of claim 1, wherein at least one processor of the one or the plurality of processors is configured to instruct the unmanned aerial vehicle to ignore and/or cancel all remaining or further commands during the landing sequence.

4. The circuit of claim 1, further comprising:
wherein at least one processor of the one or the plurality of processors is configured to process data representing a geo-fenced region.

5. The circuit of claim 4,
wherein at least one processor of the one or the plurality of processors is configured to repeatedly determine a positional status of the unmanned aerial vehicle regarding the geo-fenced region.

6. The circuit of claim 1, further comprising:
wherein at least one processor of the one or the plurality of processors is configured to operate one or more than one light source of the unmanned aerial vehicle according to the light emission sequence.

7. A system for emergency operation, comprising:
at least one stationary optoelectronic emitter configured to repeatedly emit an alert command with a line-beam emission characteristic into a direction having a vertical component;
at least one unmanned aerial vehicle comprising an optoelectronic sensor;
wherein the unmanned aerial vehicle is configured to implement at least one sequence of the following sequences:
a landing sequence bringing the unmanned aerial vehicle to land or to discontinue flight; or
a light emission sequence of pulsed or sustained light;
wherein the unmanned aerial vehicle is further configured to initiate the at least one sequence in response to the alert command received via the optoelectronic sensor.

8. The system of claim 7, wherein the at least one stationary optoelectronic emitter comprises at least one solid-state light source.

9. The system of claim 7, wherein the at least one stationary optoelectronic emitter comprises at least one laser.

10. The system of claim 7, wherein the at least one stationary optoelectronic emitter comprises at least one infrared emitter.

11. The system of claim 7, wherein the line-shaped emission characteristic defines a first emission divergence and a second emission divergence regarding the direction of the emission, wherein the first emission divergence and the second beam divergence are perpendicular to each other and have a ratio to each other of less than 10⁻¹.

12. The system of claim 7, wherein the at least one stationary optoelectronic emitter is configured to emit the alert command into a spatial region, which is isolated from and/or disturbed in radio communication.

13. The system of claim 7, wherein the at least one stationary optoelectronic emitter is configured to repeatedly emit the alert command in response to the unmanned aerial vehicle flying or at least while the unmanned aerial vehicle is flying.

14. The system of claim 7, wherein the unmanned aerial vehicle includes data representing a geo-fenced region.

15. The system of claim 14,
wherein the line-beam emission characteristic separates a protected region and the geo-fenced region, wherein the protected region includes at least one person and/or includes more persons than the geo-fenced region.

16. The system of claim 14,
wherein the at least one stationary optoelectronic emitter includes a plurality of stationary optoelectronic emitters surrounding the geo-fenced region.

17. A computer-readable medium storing instructions, when executed by a processor, implementing a method comprising:
detecting an aerial vehicle approaching a geo-fenced region from outside the geo-fenced region;
at least one optoelectronic emitter emitting an alert command into the geo-fenced region in response to detecting the aerial vehicle;
an optoelectronic sensor of an unmanned aerial vehicle flying in the geo-fenced region receiving the alert command;
the unmanned aerial vehicle initiating at least one of the following sequences in response to receiving the alert command:
a landing sequence bringing the unmanned aerial vehicle to land or to discontinue flight; or
a light emission sequence of pulsed or sustained light.

18. The computer-readable medium of claim 17,
wherein the aerial vehicle is a manned aerial vehicle.

19. A computer-readable medium storing instructions, when executed by a processor, implementing a method comprising:
at least one stationary optoelectronic emitter repeatedly emitting an alert command with a line-beam emission characteristic into a direction having a vertical component;
an optoelectronic sensor of a flying unmanned aerial vehicle receiving the alert command from the stationary optoelectronic emitter;
the unmanned aerial vehicle initiating a landing sequence in response to receiving the alert command, wherein the landing sequence brings the unmanned aerial vehicle to land or to discontinue flight.

20. The computer-readable medium of claim 19, wherein the landing sequence triggers the unmanned aerial vehicle to perform at least one of the following:
stop all motors;
stabilize its orientation;
return to a predefined position; or
control a descent speed.
